(19) United States
(12) Patent Application Publication
(10) Pub. No.: US 2024/0007949 A1
(43) Pub. Date: Jan. 4, 2024

(54) INFORMATION PROCESSING DEVICE, INFORMATION PROCESSING METHOD, AND PROGRAM

(71) Applicant: SONY SEMICONDUCTOR SOLUTIONS CORPORATION, KANAGAWA (JP)

(72) Inventor: ATSUSHI MORI, KANAGAWA (JP)

(21) Appl. No.: 18/253,968

(22) PCT Filed: Nov. 19, 2021
(86) PCT No.: PCT/JP2021/042526

§ 371 Date: May 23, 2023

(30) Foreign Application Priority Data
Dec. 4, 2020 (JP) 2020-201543

(51) Int. Cl. H04W 52/02

(52) U.S. Cl. CPC H04W 52/0225

(57) ABSTRACT

The present technology relates to an information processing device, an information processing method, and a program capable of reducing power required for wireless communication.

An acknowledgement is transmitted to a connection device connected by wireless communication in a case where transmission data transmitted from the connection device has been received normally, and a negative acknowledgement is transmitted to the connection device in a case where the transmission data has not been received normally. In a case where the negative acknowledgement is transmitted to the connection device and there is no data body to be transmitted to the connection device, transmission power for transmitting the negative acknowledgement is set to low power lower than normal power that is transmission power for transmitting other data.

### TECHNICAL FIELD

The present technology relates to an information processing device, an information processing method, and a program, and more particularly, to an information processing device, an information processing method, and a program capable of reducing power required for wireless communication.

### BACKGROUND ART

Patent Documents 1 and 2 disclose a technology for reducing or limiting power consumption in wireless communication.

### CITATION LIST

### Patent Document

Patent Document 1: Japanese Patent Application National Publication (Laid-Open) No. 2016-525854
Patent Document 2: Japanese Patent No. 5171523

### SUMMARY OF THE INVENTION

### Problems to be Solved by the Invention

Since wireless communication in a portable device or the like accelerates power consumption of a battery, it is desired to reduce power required for wireless communication.

The present technology has been made in view of such a situation, and enables reduction in power required for wireless communication.

### Solutions to Problems

An information processing device or a program of the present technology is an information processing device including a communication unit that transmits an acknowledgement to a connection device connected by wireless communication in a case where transmission data transmitted from the connection device has been received normally, and transmits a negative acknowledgement to the connection device in a case where the transmission data has not been received normally, in which the communication unit sets transmission power for transmitting the negative acknowledgement to low power lower than normal power that is transmission power for transmitting other data in a case where the negative acknowledgement is transmitted to the connection device and there is no data body to be transmitted to the connection device, or a program for causing a computer to function as such an information processing device.

An information processing method of the present technology is an information processing method including the steps of a communication unit of an information processing device including the communication unit transmitting an acknowledgement to a connection device connected by wireless communication in a case where transmission data transmitted from the connection device has been received normally, and transmitting a negative acknowledgement to the connection device in a case where the transmission data has not been received normally, and in a case where the negative acknowledgement is transmitted to the connection device and there is no data body to be transmitted to the connection device, setting transmission power for transmitting the negative acknowledgement to low power lower than normal power that is transmission power for transmitting other data.

In the information processing device, the information processing method, and the program of the present technology, an acknowledgement is transmitted to a connection device connected by wireless communication in a case where transmission data transmitted from the connection device has been received normally, and a negative acknowledgement is transmitted to the connection device in a case where the transmission data has not been received normally. In a case where the negative acknowledgement is transmitted to the connection device and there is no data body to be transmitted to the connection device, transmission power for transmitting the negative acknowledgement is set to low power lower than normal power that is transmission power for transmitting other data.

### BRIEF DESCRIPTION OF DRAWINGS

FIG. 1 is a block diagram illustrating a configuration example of an embodiment of an information processing system to which the present technology is applied.

FIG. 2 is blocks illustrating a configuration example of a communication unit of a slave.

FIG. 3 is a diagram illustrating a timeline of data transmission performed between a master and a slave.

FIG. 4 is a diagram illustrating a packet format in BLE.

FIG. 5 is a flowchart illustrating a procedure of a first mode of data transmission processing (data transmission processing) performed by the communication unit of the slave.

FIG. 6 is a diagram illustrating a timeline in a case where a master has not received a packet transmitted by a slave normally.

FIG. 7 is a diagram illustrating a timeline of data transmission in a case where ACL transmission is used as a data transmission method between the master and the slave.

FIG. 8 is a diagram illustrating a timeline of data transmission in a case where ACL transmission is used as a data transmission method between the master and the slave.

FIG. 9 is a flowchart illustrating a procedure of a second mode of data transmission processing (data transmission processing) performed by the communication unit of the slave.

FIG. 10 is a diagram illustrating a third mode of data transmission processing.

FIG. 11 is a flowchart illustrating a procedure of the third mode of data transmission processing performed by the communication unit of the slave.

FIG. 12 is a block diagram illustrating a configuration example of the communication unit of the master in FIG. 1.

FIG. 13 is a block diagram illustrating a configuration example of hardware of a computer that executes a series of processing by a program.

### MODES FOR CARRYING OUT THE INVENTION

Hereinafter, embodiments of the present technology will be described with reference to the drawings.

### Embodiment of Information Processing System

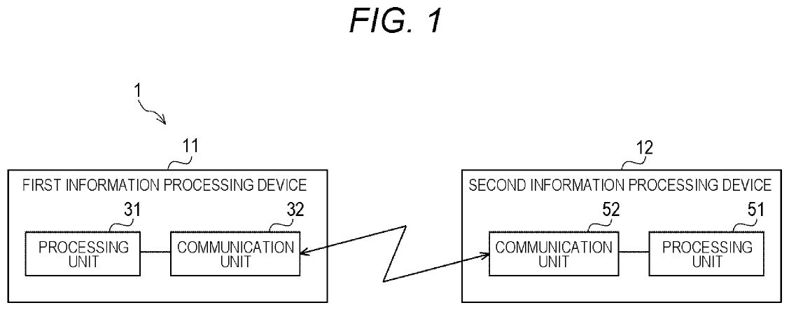

FIG. 1 is a block diagram illustrating a configuration example of an embodiment of an information processing system to which the present technology is applied.

In FIG. 1, an information processing system 1 which is an embodiment of an information processing system to which the present technology is applied includes a first information processing device 11 and a second information processing device 12.

The first information processing device 11 and the second information processing device 12 are not limited to a device that performs a specific type of information processing, and may be any device such as a personal computer, a smartphone, a music reproducing device, a keyboard, a mouse, or a camera. The first information processing device 11 and the second information processing device 12 are communicably connected by short-range wireless communication based on the Bluetooth (registered trademark) standard. The first information processing device 11 and the second information processing device 12 are connection devices connected to each other by wireless communication. In the wireless communication between the first information processing device 11 and the second information processing device 12, the first information processing device 11 operates as a master, and the second information processing device 12 operates as a slave.

Hereinafter, the first information processing device 11 is also referred to as a master 11, and the second information processing device 12 is also referred to as a slave 12. Note that the connection between the master 11 and the slave 12 by wireless communication is not limited to the case of short-range wireless communication based on the Bluetooth (registered trademark) standard. The present technology can be applied to any short-range wireless communication or wireless communication.

The master 11 includes a processing unit 31 and a communication unit 32.

The processing unit 31 executes a program stored in a storage unit (not illustrated) of the master 11 and executes processing according to the program. The processing unit 31 supplies data (data body) to be transmitted to the slave 12 to the communication unit 32. The processing unit 31 acquires the data (data body) transmitted by the slave 12 via the communication unit 32.

The communication unit 32 performs processing such as encapsulation and modulation on the data body supplied from the processing unit 31. As a result, the communication unit 32 generates transmission data (packet having predetermined bit length) conforming to the Bluetooth (registered trademark) standard and transmits the transmission data to the slave 12 as radio waves. The communication unit 32 receives the transmission data transmitted as radio waves by the slave 12. The communication unit 32 performs processing such as demodulation and decapsulation on the received transmission data, and supplies the data body to the processing unit 31.

The slave 12 includes a processing unit 51 and a communication unit 52.

The processing unit 51 executes a program stored in a storage unit (not illustrated) of the slave 12 and executes processing according to the program. The processing unit 51 supplies data (data body) to be transmitted to the master 11 to the communication unit 52. The processing unit 51 acquires the data (data body) transmitted by the master 11 via the communication unit 52.

The communication unit 52 performs processing such as encapsulation and modulation on the data body supplied from the processing unit 51. As a result, the communication unit 52 generates transmission data (packet having predetermined bit length) conforming to the Bluetooth (registered trademark) standard and transmits the transmission data to the master 11 as radio waves. The communication unit 52 receives the transmission data (packet) transmitted as radio waves by the master 11. The communication unit 52 performs processing such as demodulation and decapsulation on the received transmission data, and supplies the data body to the processing unit 51.

<Configuration of Communication Unit 52 of Slave 12>

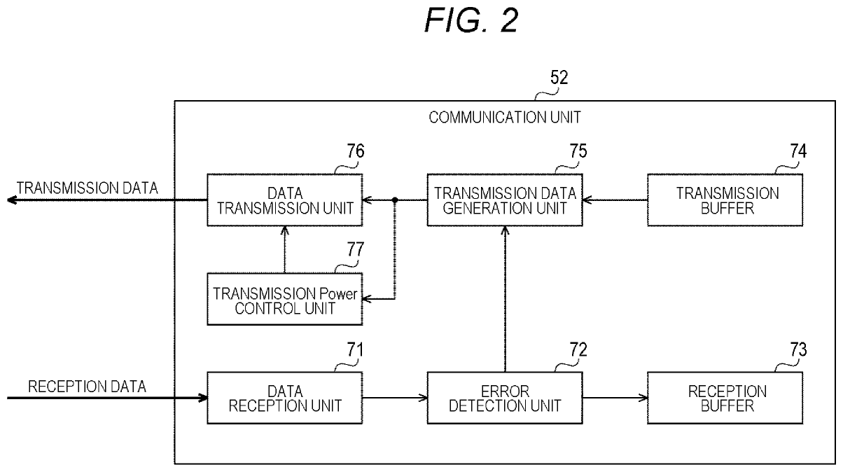

FIG. 2 is blocks illustrating a configuration example of the communication unit 52 of the slave (second information processing device) 12.

The communication unit 52 includes a data reception unit 71, an error detection unit 72, a reception buffer 73, a transmission buffer 74, a transmission data generation unit 75, a data transmission unit 76, and a transmission power control unit 77.

The data reception unit 71 receives, as reception data, transmission data (packet) transmitted as radio waves by the master 11. The data reception unit 71 demodulates the received reception data and supplies the demodulated data to the error detection unit 72.

The error detection unit 72 detects a transmission error on the basis of the reception data from the data reception unit 71. In a case where a transmission error is detected, the error detection unit 72 supplies an error detection signal providing notification of the fact to the transmission data generation unit 75. The transmission error is detected on the basis of an error detection code such as a cyclic redundancy check (CRC) added to the reception data. In a case where no transmission error is detected, the error detection unit 72 supplies the reception data from the data reception unit 71 to the reception buffer 73.

The reception buffer 73 temporarily stores the reception data from the error detection unit 72. The reception data stored in the reception buffer 73 is subjected to processing such as decapsulation by a processing unit (not illustrated), and a data body is extracted and supplied to the processing unit 51 in FIG. 1.

The transmission buffer 74 temporarily stores the data body supplied from the processing unit 51 in FIG. 1, and supplies the data body to the transmission data generation unit 75.

The transmission data generation unit 75 performs processing such as encapsulation on the data body from the transmission buffer 74, and generates transmission data to be transmitted to the master 11. The transmission data generation unit 75 supplies the generated transmission data to the data transmission unit 76. In a case where an error detection signal is supplied from the error detection unit 72, the transmission data generation unit 75 generates transmission data including a negative acknowledgement (NACK).

The data transmission unit 76 modulates the transmission data from the transmission data generation unit 75 and outputs (transmits) transmission data as radio waves.

The transmission power control unit 77 controls the radio field intensity (transmission power) output from the data transmission unit 76 on the basis of the transmission data from the transmission data generation unit 75.

<First Mode of Data Transmission Processing in Slave 12>

A first mode of data transmission processing (data transmission processing) in the slave 12 will be described.

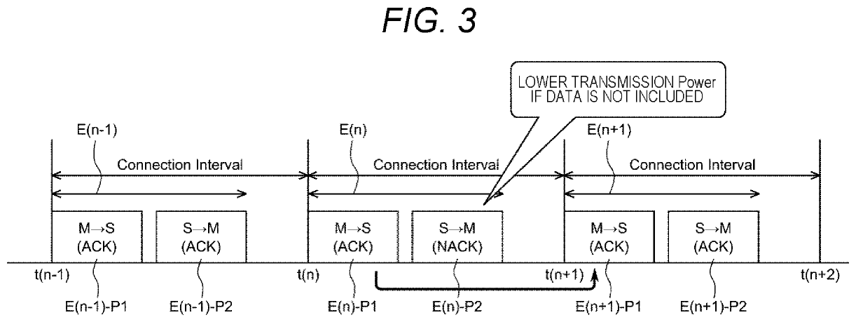

FIG. 3 is a diagram illustrating a timeline of data transmission performed between the master 11 and the slave 12.

The timeline in FIG. 3 represents a part of a period of data transmission after a connection between the master 11 and the slave 12 is established (after connected state).

After the connected state, data is transmitted and received (data transmission) between the master 11 and the slave 12 at regular time intervals. The period is referred to as a connection interval. Data transmission is performed by dividing data into packets having a predetermined bit length. Times t(n−1), t(n), and t(n+1) in FIG. 3 represent start times of (n−1)th, n th, and (n+1)th (n is positive integer) connection intervals, respectively. Data transmission (packet transmission) in each connection interval is referred to as a connection event. That is, a connection event occurs within the time of a connection interval. Connection events E(n−1), E(n), and E(n+1) in FIG. 3 represent (n−1)th, n th, and (n+1)th connection events, respectively.

In each connection event, one or more packets are transmitted during the connection interval. In the example of FIG. 3, two packets are transmitted in each connection event. Packets E(n−1)-P1, E(n)-P1, and E(n+1)-P1 denoted with “M→S” in FIG. 3 represent packets transmitted by the master 11 to the slave 12 in connection events E(n−1), E(n), and E(n+1), respectively, and packets E(n−1)-P2, E(n)-P2, and E(n+1)-P2 denoted with “S→M” represent packets transmitted by the slave 12 to the master 11 in connection events E(n−1), E(n), and E(n+1), respectively.

Each packet includes information of an acknowledgement (ACK) or a negative acknowledgement (NACK). An acknowledgement (ACK) indicates that the master 11 or the slave 12 has received a packet transmitted from the communication partner normally. A negative acknowledgement (NACK) indicates that the master 11 or the slave 12 has not received a packet transmitted from the communication partner normally. In the example of FIG. 3, all the packets E(n−1)-P1, E(n)-P1, and E(n+1)-P1 transmitted by the master 11 to the slave 12 include an acknowledgement (ACK). For example, the acknowledgement (ACK) included in the packet E(n)-P1 indicates that the master 11 has received the previous (latest) packet E(n−1)-P2 transmitted by the slave 12 to the master 11 normally.

In the example of FIG. 3, of the packets E(n−1)-P2, E (n)-P2, and E(n+1)-P2 transmitted by the slave 12 to the master 11, an acknowledgement (ACK) is included in the packets E (n−1)-P2 and E(n+1)-P2, and a negative acknowledgement (NACK) is included in the packet E(n)-P2. For example, the negative acknowledgement (NACK) of the packet E(n)-P2 indicates that the slave 12 has not received the previous (latest) packet E(n)-P1 transmitted by the master 11 to the slave 12 normally.

When receiving a packet including a negative acknowledgement (NACK) from the communication partner, the master 11 or the slave 12 retransmits a packet including the same data body as the previous packet. In the example of FIG. 3, when receiving the packet E(n)-P2 including the negative acknowledgement (NACK), the master 11 retransmits, to the slave 12, the packet E(n+1)-P1 including the same data body as the packet E(n)-P1 transmitted to the slave 12 last time. Retransmission of a packet transmitted by the master 11 in a predetermined connection interval (connection event) is performed in the next connection interval (connection event).

Note that the master 11 retransmits the previous (latest) packet transmitted to the slave 12 also in a case where a packet including an acknowledgement (ACK) or a negative acknowledgement (NACK) transmitted from the slave 12 for a packet transmitted to the slave 12 has not been received normally. Retransmission in this case, too, is performed for the connection interval (connection event) in which the original packet is transmitted in the next connection interval (connection event).

The above data transmission processing in the master 11 and the slave 12 is basic processing content performed in wireless communication based on the Bluetooth (registered trademark) standard.

In the first mode of data transmission processing in the slave 12, the slave 12 performs the following processing. Note that a packet including an acknowledgement (ACK) is also simply referred to as an acknowledgement (ACK) or an acknowledgement (ACK) packet, and a packet including a negative acknowledgement (NACK) is also simply referred to as a negative acknowledgement (NACK) or a negative acknowledgement (NACK) packet.

In the first mode of the data transmission processing, in a case where the slave 12 transmits a negative acknowledgement (NACK) to the master 11, when there is no data body to be transmitted to the master 11, the transmission power of the negative acknowledgement (NACK) is reduced to be lower than normal power. Normal power is the transmission power for transmitting a packet other than the packet for which the transmission power is reduced, and is determined according to the distance between the master 11 and the slave 12, the radio wave condition, and the like.

In FIG. 1, in a case where a packet that is transmission data generated by the transmission data generation unit 75 includes a negative acknowledgement (NACK) and does not include a data body, the transmission power control unit 77 of the slave 12 reduces the radio field intensity when the data transmission unit 76 outputs the packet as transmission data to be lower than the normal intensity. As a result, the transmission power when the slave 12 transmits a negative acknowledgement (NACK) without a data body to the master 11 is reduced, and power consumption in the slave 12 is reduced. Note that the transmission power at the time when the slave 12 transmits a negative acknowledgement (NACK) without a data body only needs to be low power (power lower than normal power) lower than normal power, and can be set to 0, for example. In a case where the transmission power is 0, no negative acknowledgement is transmitted.

By thus reducing the transmission power of the negative acknowledgement (NACK) without a data body to be lower than normal power, power consumption in the slave 12 is reduced. Note, however, that in a case where the slave 12 reduces the transmission power of the negative acknowledgement (NACK), a situation in which the master 11 cannot receive the negative acknowledgement (NACK) from the slave 12 normally may occur. However, even in a case where such a situation occurs, similarly to the case where the negative acknowledgement (NACK) from the slave 12 has been received normally, the master 11 retransmits the previous (latest) packet transmitted to the slave 12, that is, the packet that the slave 12 has not received normally, and thus, no special problem occurs.

Even in a case of transmitting a negative acknowledgement (NACK) to the master 11, when there is a data body to be transmitted to the master 11 together with the negative acknowledgement (NACK) (when there is data body to be transmitted in same packet as negative acknowledgement), the slave 12 transmits the negative acknowledgement (NACK) and the data body at normal power without reducing the transmission power. Therefore, a situation in which the master 11 cannot receive a data body to be transmitted to the master 11 normally due to reduction in transmission power does not occur.

### Example of Packet Format

In order to exemplify modes of acknowledgement (ACK) and negative acknowledgement (NACK), a packet format in Bluetooth (registered trademark) Low Energy (hereinafter referred to as BLE), which is one of the Bluetooth (registered trademark) standards, will be described.

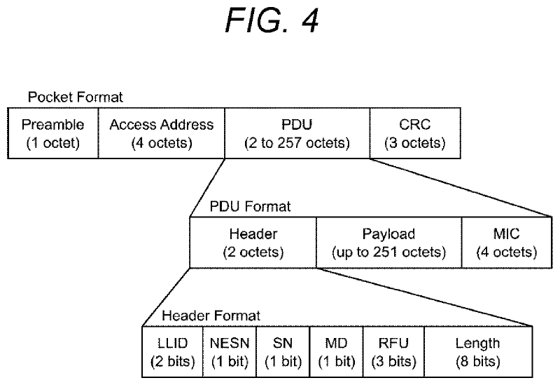

FIG. 4 is a diagram illustrating a packet format in BLE.

The packet format of FIG. 4 represents a structure of a packet (data packet) when a data body is transmitted after the master 11 and the slave 12 are transferred from an advertising state to a connected state.

A packet in BLE includes a “Preasenble” field, an “Access Addres” field, a “PDU” (protocol data unit) field, and a “CRC” (cyclic redundancy check) field.

“Preasenble” is a signal for taking a timing in units of bits in a packet reception-side device. “Access addres” is identification information of the packet reception-side device. “Access Addres” is used by the packet reception-side device to determine whether the packet is a packet transmitted to the packet reception-side device. “CRC” is an error detection code, and is used by the packet reception-side device to detect an error/damage of a packet.

“PDU” includes a data body (application layer data) to be transmitted by the packet transmission-side device to the packet reception-side device. “PDU” includes a “Header” field, a “Payload” field, and a “MIC” (message integrity check) field.

“Payload” is a data body to be transmitted from the packet transmission-side device to the packet reception-side device. “MIC” is used by the packet reception-side device to detect whether “PDU” is correctly encrypted in a case where “PDU” is encrypted.

“Header” includes an “LLID” (logical link identifier) field, an “NESN” (next expected sequence number) field, an “SN” (sequence number) field, an “MD” (more data) field, an “RFU” field, and a “Length” field.

“LLID” is a link layer identifier indicating whether the packet is an LL data PDU or an LL control PDU.

“NESN” indicates the sequence number of a packet that the packet transmission-side device requests the packet reception-side device to transmit next.

“SN” indicates the sequence number of a packet transmitted by the packet transmission-side device.

“MD” indicates the presence or absence of data to be continuously transmitted by the packet transmission-side device.

“RFU” is a reserved field for future use.

“Length” indicates a data size of “Payload” and “MIC” (when present).

In such a packet format, information of an acknowledgement (ACK) and a negative acknowledgement (NACK) is included in the packet as information of “NESN” and “SN”. “NESN” and “SN” of a packet are set to 0 or 1 as a sequence number.

In a case where a packet has been received normally, the packet reception-side device transmits a packet in which “NESN” is set to a sequence number different from “SN” as an acknowledgement (ACK) to the packet transmission-side device (communication partner).

For example, in a case where a packet with “SN” set to 0 transmitted from the master 11 has been received normally, the slave 12 transmits a packet with “NESN” set to 1 to the master 11. In a case where a packet with “SN” set to 1 transmitted from the master 11 has been received normally, the slave 12 transmits a packet with “NESN” set to 0 to the master 11. In these cases, since transmission of a packet having a sequence number different from “SN” of the previous packet transmitted to the slave 12 is requested by “NESN”, the master 11 determines that the packet is an acknowledgement (ACK). When determining that the received packet is an acknowledgement (ACK), the master 11 transmits, to the slave 12, a packet in which a data body subsequent to a data body (data of “Payload”) of a previous packet transmitted to the slave 12 is set as data of “Payload”. At this time, the master 11 sets “SN” of the packet to be transmitted to the slave 12 to a sequence number different from “SN” of the previous packet.

In a case where a packet has not been received normally, the packet reception-side device transmits a packet in which “NESN” is set to the same sequence number as “SN” as a negative acknowledgement (NACK) to the packet transmission-side device (communication partner).

For example, in a case where a packet with “SN” set to 0 transmitted from the master 11 has not been received normally, the slave 12 transmits a packet with “NESN” set to 0 to the master 11. In a case where a packet with “SN” set to 1 transmitted from the master 11 has not been received normally, the slave 12 transmits a packet with “NESN” set to 1 to the master 11. In these cases, since transmission of a packet having the same sequence number as “SN” of the previous packet transmitted to the slave 12 is requested by “NESN”, the master 11 determines that the packet is a negative acknowledgement (NACK). When determining that the received packet is a negative acknowledgement (NACK), the master 11 transmits, to the slave 12, a packet in which the same data body as the data body (data of “Payload”) of the previous packet transmitted to the slave 12 is set as data of “Payload”. At this time, the master 11 sets “SN” of the packet to be transmitted to the slave 12 to the same sequence number as “SN” of the previous packet.

<Processing Procedure of First Mode of Data Transmission Processing in Slave 12>

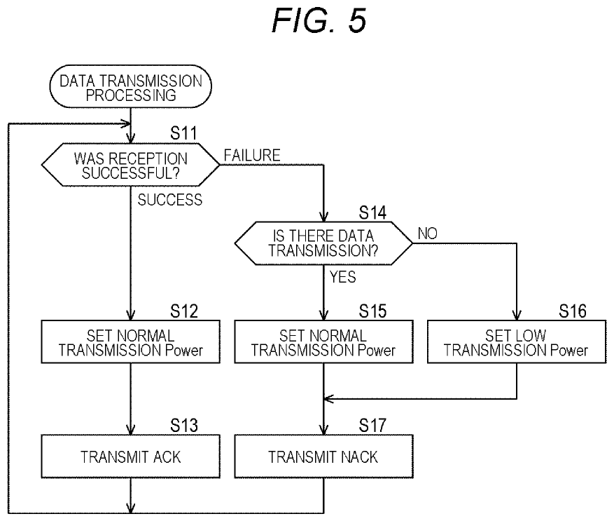

FIG. 5 is a flowchart illustrating a procedure of the first mode of the data transmission processing (data transmission processing) performed by the communication unit 52 of the slave 12.

In step S11, the error detection unit 72 (see FIG. 2) in the communication unit 52 of the slave 12 determines whether the reception was successful or has failed. That is, the error detection unit 72 determines whether or not the packet transmitted by the master 11 has been received normally.

If it is determined in step S11 that the reception was successful, the processing proceeds to step S12. Note that if it is determined that the reception was successful, the error detection signal is not supplied from the error detection unit 72 to the transmission data generation unit 75. In this case, the transmission data generation unit 75 (see FIG. 2) generates an acknowledgement (ACK) (packet including acknowledgement (ACK)) as transmission data, and supplies the transmission data to the data transmission unit 76 and the transmission power control unit 77 (see FIG. 2). In a case where a data body to be transmitted to the master 11 is supplied from the processing unit 51 (see FIG. 1) via the transmission buffer 74 (see FIG. 2), the transmission data generation unit 75 generates a packet including an acknowledgement response (ACK) and the data body as transmission data. In a case where a data body to be transmitted to the master 11 is not supplied from the processing unit 51 via the transmission buffer 74, the transmission data generation unit 75 generates a packet including an acknowledgement response (ACK) and not including a data body as transmission data.

In step S12, the transmission power control unit 77 detects that the transmission data (packet) generated by the transmission data generation unit 75 is an acknowledgement (ACK) on the basis of the transmission data from the transmission data generation unit 75. At this time, the transmission power control unit 77 sets the transmission power (radio field intensity) for transmitting an acknowledgement (ACK) from the data transmission unit 76 to normal power. The processing proceeds from step S12 to step S13. Note that the transmission power control unit 77 may detect that the transmission data generated by the transmission data generation unit 75 is an acknowledgement (ACK) not on the basis of transmission data from the transmission data generation unit 75, but by acquiring information on whether or not the reception was successful from the error detection unit 72 or the transmission data generation unit 75.

In step S13, the data transmission unit 76 transmits the acknowledgement (ACK) from the transmission data generation unit 75 with normal power set in step S12. The processing returns from step S13 to step S11, and the processing from step S11 is repeated.

If it is determined in step S11 that the reception has failed, the processing proceeds to step S14. Note that if it is determined that the reception has failed, an error detection signal is supplied from the error detection unit 72 to the transmission data generation unit 75. In this case, the transmission data generation unit 75 generates a negative acknowledgement (NACK) (packet including negative acknowledgement (NACK)) as transmission data and supplies the transmission data to the data transmission unit 76 and the transmission power control unit 77. In a case where a data body to be transmitted to the master 11 is supplied from the processing unit 51 (see FIG. 1) via the transmission buffer 74 (see FIG. 2), the transmission data generation unit 75 generates a packet including a negative acknowledgement (NACK) and the data body as transmission data. In a case where a data body to be transmitted to the master 11 is not supplied via the transmission buffer 74, the transmission data generation unit 75 generates a packet including a negative acknowledgement (NACK) and not including a data body as transmission data.

In step S14, the transmission power control unit 77 detects that the transmission data (packet) generated by the transmission data generation unit 75 is a negative acknowledgement (NACK) on the basis of the transmission data from the transmission data generation unit 75. At this time, the transmission power control unit 77 determines whether or not there is a data body to be transmitted to the master 11 along with a negative acknowledgement (NACK) (whether or not there is data transmission). That is, it is determined whether or not a data body (“Payload” data that is not empty) is included in the transmission data (packet) generated by the transmission data generation unit 75. Note that the transmission power control unit 77 may detect that the transmission data generated by the transmission data generation unit 75 is a negative acknowledgement (NACK) not on the basis of transmission data from the transmission data generation unit 75, but by acquiring information on whether or not the reception was successful from the error detection unit 72 or the transmission data generation unit 75. The determination in step S14, too, can be made by the transmission power control unit 77 not on the basis of transmission data from the transmission data generation unit 75, but by acquiring information on whether or not there is a data body to be transmitted to the master 11 from the transmission data generation unit 75.

If it is determined in step S14 that there is a data body to be transmitted to the master 11 along with the negative acknowledgement (NACK), the processing proceeds to step S15.

In step S15, the transmission power control unit 77 sets the transmission power (radio field intensity) for transmitting the negative acknowledgement (NACK) (packet including negative acknowledgement (NACK) and data body) from the data transmission unit 76 to normal power. The processing proceeds from step S15 to step S17.

If it is determined in step S14 that there is no data body to be transmitted to the master 11 along with the negative acknowledgement (NACK), the processing proceeds to step S16.

In step S16, the transmission power control unit 77 sets the transmission power (radio field intensity) for transmitting the negative acknowledgement (NACK) from the data transmission unit 76 to low power lower than normal power. The processing proceeds from step S16 to step S17.

In step S17, the data transmission unit 76 transmits the transmission data (packet) from the transmission data generation unit 75 with the transmission power set in step S15 or step S16.

The processing returns from step S17 to step S11, and the processing from step S11 is repeated.

Note that the determination processing in step S11 may represent processing in the transmission power control unit 77 instead of the error detection unit 72.

(Effectiveness of First Mode of Data Transmission Processing in Slave 12)

The effectiveness of the first mode of data transmission processing in the slave 12 will be described.

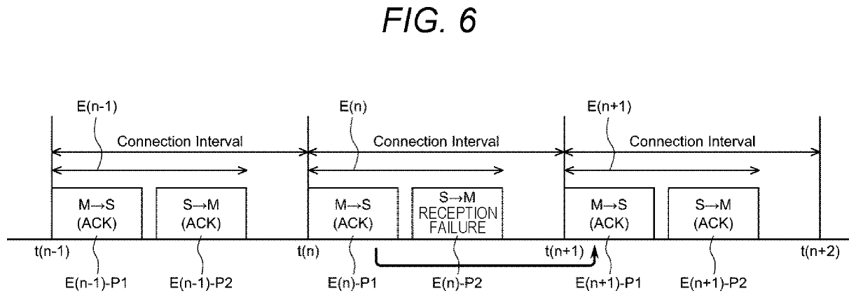

FIG. 6 is a diagram illustrating a timeline in a case where the master 11 fails to receive the packet E(n)-P2 transmitted by the slave 12 in the n th connection event E(n) in the timeline of FIG. 3 normally. Note that in FIG. 6, parts corresponding to those in the timeline of FIG. 3 are denoted by the same reference numerals, and description thereof will be omitted.

In a case where the packet E(n)-P2 transmitted by the slave 12 has not been received normally (when reception has failed), the master 11 cannot determine whether or not the slave 12 has received the previous packet E(n)-P1 transmitted to the slave 12 normally. Therefore, similarly to the case of receiving a negative acknowledgement (NACK) from the slave 12, the master 11 retransmits the packet E(n+1)-P1 including the same data body as the previous packet E(n)-P1 transmitted to the slave 12 in the (n+1)th connection event E(n+1).

Comparing FIG. 3 with FIG. 6, regarding the data body transmitted by the master 11 to the slave 12, the data bodies transmitted in the n th connection interval (connection event E (n)) are retransmitted in the next (n+1)th connection interval (connection event E(n+1)). In a case where the transmission power of a negative acknowledgement (NACK) transmitted by the slave 12 to the master 11 is reduced to be lower than normal power as in the first mode, the possibility that the master 11 cannot receive the negative acknowledgement (NACK) normally increases. However, even in a case where the master 11 has not received the negative acknowledgement (NACK) normally, similarly to a case where the master 11 has received the negative acknowledgement (NACK) normally, the master 11 retransmits the data body that the slave 12 has not received normally, and thus, no problem occurs. In particular, in a case where only two packets are transmitted during a connection interval of one period as illustrated in FIGS. 3 and 6, the transmission efficiency of the data body transmitted by the master 11 to the slave 12 is the same between the case of FIG. 3 and the case of FIG. 6. As described above, by reducing the transmission power in a case where the slave 12 transmits a negative acknowledgement (NACK) to the master 11, the data transmission from the master 11 to the slave 12 is performed with no problem, and the power consumption of the slave 12 is reduced.

On the other hand, regarding the data body to be transmitted by the slave 12 to the master 11, if the transmission power of a negative acknowledgement (NACK) to be transmitted by the slave 12 to the master 11 is reduced, the transmission efficiency may be reduced. That is, assume that the transmission power of the negative acknowledgement (NACK) is reduced in a case where a data body is included in the packet of the negative acknowledgement (NACK). In this case, the possibility that the master 11 cannot receive the packet of the negative acknowledgement (NACK) normally increases. If the master 11 cannot receive the packet of the negative acknowledgement (NACK) normally, it is necessary to retransmit the data body included in the packet. Therefore, in the first mode, in a case where the slave 12 transmits a negative acknowledgement (NACK) to the master 11, when a data body is included in a packet of the negative acknowledgement (NACK) (when there is data body associated with negative acknowledgement (NACK)), the slave 12 does not reduce the transmission power of the negative acknowledgement (NACK).

Note that Patent Document 1 (Japanese Patent Application Laid-Open No. 2016-525854) discloses that there are a data channel and an ACK/NACK transmission channel, and the transmission power on the data channel side is reduced to ensure flow control and the transmission power of a NACK. This is different from the present technology for reducing the transmission power of a NACK to reduce power consumption.

In Patent Document 2 (Japanese Patent No. 5171523), in a configuration in which an ACK and a NACK are transmitted in a channel different from data transmission, determination of an ACK and a NACK is performed by the power level. Since a NACK and a non-signal are treated similarly, it is disclosed that the power of a NACK is reduced. According to this, since the present technology has a configuration in which a data body is transmitted along with an ACK and a NACK, the present technology is different from Patent Document 2. The present technology is different from Patent Document 2 in that the transmission power of a NACK is reduced in a case where there is no data body associated with the NACK.

<Second Mode of Data Transmission Processing in Slave 12>

A second mode of data transmission processing in the slave 12 will be described.

In the Bluetooth (registered trademark) standard, several methods can be used as a data transmission method, and examples of the data transmission method include ACL transmission and ISO transmission.

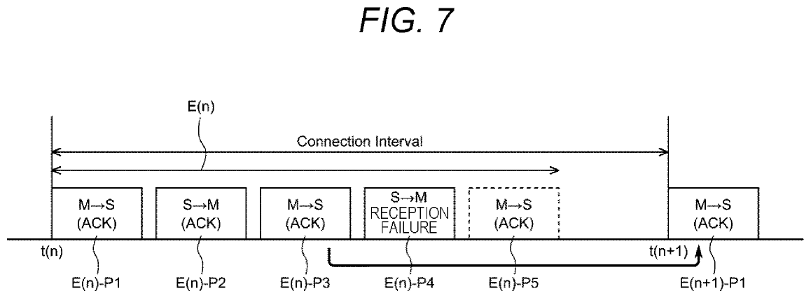

FIG. 7 is a diagram illustrating a timeline of data transmission in a case where ACL transmission is used as the data transmission method between the master 11 and the slave 12.

The timeline in FIG. 7 represents a part of a period of data transmission after a connection between the master 11 and the slave 12 is established (after connected state).

Times t(n) and t(n+1) represent start times of the n th and (n+1)th (n is positive integer) connection intervals, respectively. The connection event E(n) represents the nth connection event.

In the ACL transmission method, a plurality of packets is transmitted at the time of a connection event in each connection interval. In the example of FIG. 7, the packets E(n)-P1, E (n)-P3, and E(n+1)-P5 denoted with “M→S” represent packets transmitted by the master 11 to the slave 12 in the connection event E(n), and the packets E(n)-P2 and E(n)-P4 denoted with “S→M” represent packets transmitted by the slave 12 to the master 11 in the connection event E(n). The packet E (n+1)-P1 denoted with “M→S” represents a part of packets transmitted in the connection event E(n+1) in the (n+1)th connection interval and represents a packet transmitted by the master 11 to the slave 12.

For example, assume that the master 11 has not received the packet E(n)-P4 transmitted from the slave 12 to the master 11 in the connection event E(n) normally. In this case, the master 11 stands by for the packet E(n)-P4 to be transmitted from the slave 12 in the connection event E(n). Therefore, the master 11 cannot transmit next packet E(n)-P5 in the connection event E(n). When the period of the connection event E(n) elapses, the master 11 determines that the packet E(n)-P4 has not been received normally. In the connection event E(n+1) of the next connection interval starting from time t(n+1), the master 11 retransmits the packet E(n+1)-P1 including the same data body as the packet E(n)-P3 to the slave 12.

If the master 11 has received the packet E(n)-P4 transmitted by the slave 12 to the master 11 in the connection event E(n) normally, regardless of whether the packet E(n)-P4 is an acknowledgement (ACK) or a negative acknowledgement (NACK), the master 11 transmits the packet E(n)-P5 to the slave 12 in the connection event E(n). In a case where the packet E(n)-P4 is an acknowledgement (ACK), the master 11 transmits a data body following the data body of the packet E (n)-P3 to the slave 12 by the packet E(n)-P5. In a case where the packet E(n)-P4 is a negative acknowledgement (NACK), the master 11 transmits the same data body as the data body of the packet E(n)-P3 to the slave 12 by the packet E (n)-P5.

In such ACL transmission, assume that the slave 12 reduces the transmission power of a negative acknowledgement (NACK) to be lower than normal power, and due to this, the master 11 cannot receive the negative acknowledgement (NACK) normally. In this case, regardless of the presence or absence of a data body transmitted by the slave 12 to the master 11, transmission of the data body from the master 11 to the slave 12 is delayed. Therefore, in the second mode, in a case where ACL transmission is used as the data transmission method, the slave 12 sets the transmission power to normal power even when transmitting a negative acknowledgement (NACK) to the master 11. That is, when ACL transmission is used, the slave 12 always sets the transmission power of a packet to normal power.

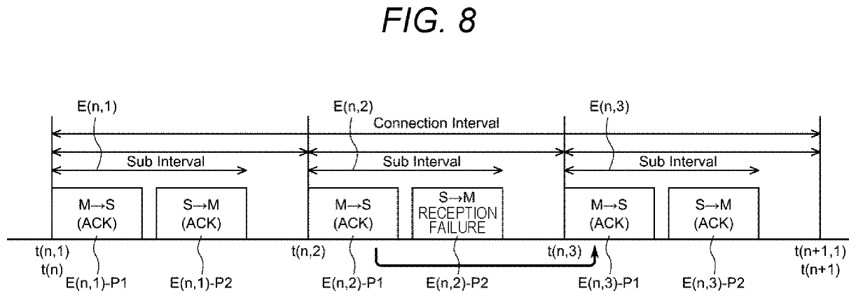

FIG. 8 is a diagram illustrating a timeline of data transmission in a case where ISO transmission is used as the data transmission method between the master 11 and the slave 12.

The timeline in FIG. 8 represents a part of a period of data transmission after a connection between the master 11 and the slave 12 is established (after connected state).

Times t(n) and t(n+1) represent start times of the n th and (n+1)th (n is positive integer) connection intervals, respectively.

In ISO transmission, each connection interval is divided into a plurality of sub intervals. In the example of FIG. 8, the connection interval is divided into three, but the present invention is not limited thereto. Times t(n, 1), t(n, 2), and t (n, 3) represent start times of first, second, and third sub-intervals in the n th connection interval, respectively.

A connection event occurs for each sub-interval. The connection events E(n, 1), E(n, 2), and E(n, 3) occur at times t(n, 1), t(n, 2), and t(n, 3), respectively.

In ISO transmission, one or more packets are transmitted in each connection event. The packets E(n, 1)-P1, E(n, 2)-P1, and E(n, 3)-P1 denoted with “M→S” represent packets transmitted by the master 11 to the slave 12 in connection events E(n, 1), E(n, 2), and E(n, 3), respectively, and the packets E(n, 1)-P2, E(n, 2)-P2, and E(n, 3)-P2 represented by “S→M” represent packets transmitted by the slave 12 to the master 11 in connection events E(n, 1), E(n, 2), and E(n, 3), respectively.

For example, assume that the master 11 has not received the packet E(n, 2)-P2 transmitted by the slave 12 to the master 11 in the connection event E(n, 2) in the second sub-interval of the n th connection interval normally. In this case, the master 11 retransmits the packet E(n, 3)-P1 including the same data body as the packet E(n, 2)-P1 to the slave 12 in the connection event (n, 3) in the third sub-interval.

If the master 11 has received the packet E(n, 2)-P2 transmitted by the slave 12 to the master 11 in the connection event E(n, 2) normally, regardless of whether the packet E(n, 2)-P2 is an acknowledgement (ACK) or a negative acknowledgement (NACK), the master 11 transmits the packet E(n, 3)-P1 to the slave 12 in the next connection event E(n, 3). In a case where the packet E(n, 2)-P2 is an acknowledgement (ACK), the master 11 transmits a data body following the data body of the packet E(n, 2)-P1 to the slave 12 by the packet E (n, 3)-P1. In a case where the packet E(n, 2)-P2 is a negative acknowledgement (NACK), the master 11 transmits the same data body as the data body of the packet E(n, 2)-P1 to the slave 12 by the packet E(n, 3)-P1.

In such ISO transmission, assume that the slave 12 reduces the transmission power of a negative acknowledgement (NACK) to be lower than normal power, and due to this, the master 11 cannot receive the negative acknowledgement (NACK) normally. Even if such a situation occurs, when there is no data body associated with a negative acknowledgement (NACK), the transmission efficiency of the data body between the master 11 and the slave 12 does not change. Therefore, in the second mode, in a case where ISO transmission is used as the data transmission method, in a case where the slave 12 transmits a negative acknowledgement (NACK) to the master 11, when there is no data body to be transmitted to the master 11, the transmission power of the negative acknowledgement (NACK) is reduced to be lower than normal power. As a result, power consumption in the slave 12 is reduced.

<Procedure of Second Mode of Data Transmission Processing>

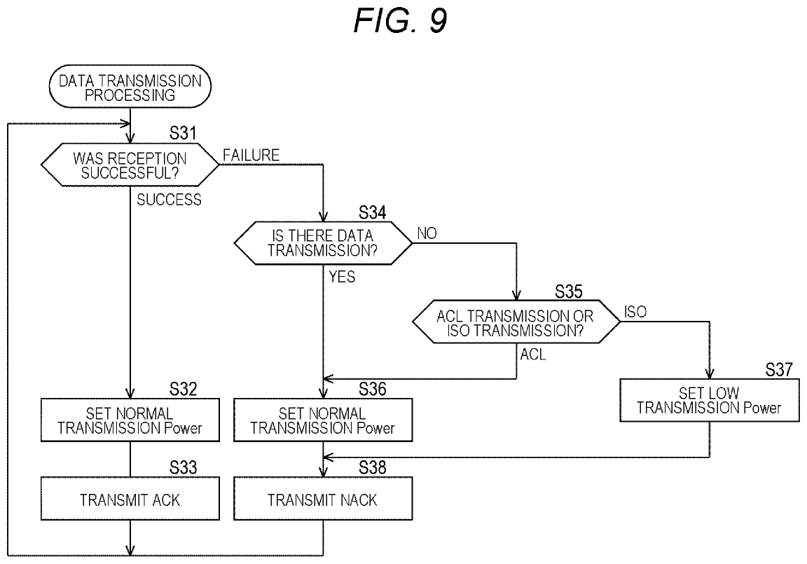

FIG. 9 is a flowchart illustrating a procedure of the second mode of data transmission processing (data transmission processing) performed by the communication unit 52 of the slave 12.

The processing of steps S31 to S33 of the flowchart of FIG. 9 is common to the processing of steps S11 to S13 of the flowchart of FIG. 5. The processing of steps S34, S36, and S38 of the flowchart of FIG. 9 is common to the processing of steps S14, S15, and S17 of the flowchart of FIG. 5. The processing of step S37 of the flowchart of FIG. 9 is common to the processing of step S16 of the flowchart of FIG. 5.

Note, however, that the flowchart of FIG. 9 is different from the flowchart of FIG. 5 in that the processing of step S35 is newly added.

In the flowchart of FIG. 9, processing in step S35 different from the flowchart of FIG. 5 will be mainly described.

The determination processing in step S35 of the flowchart in FIG. 9 is performed when it is determined in step S31 that the reception of the packet from the master 11 has failed and it is determined in step S34 that there is no data body to be transmitted to the master 11 along with a negative acknowledgement (NACK).

In step S35, the transmission power control unit 77 (see FIG. 2) determines whether the data transmission method between the master 11 and the slave 12 is ACL transmission or ISO transmission.

If it is determined in step S35 that the data transmission method is ACL transmission, the processing proceeds to step S36. In step S36, the transmission power control unit 77 sets the transmission power (radio field intensity) for transmitting a negative acknowledgement (NACK) packet from the data transmission unit 76 to normal power.

If it is determined in step S35 that the data transmission method is ISO transmission, the processing proceeds on to step S37. In step S37, the transmission power control unit 77 sets the transmission power (radio field intensity) for transmitting a negative acknowledgement (NACK) (packet not including data body) from the data transmission unit 76 to low power lower than normal power. The processing proceeds from step S37 to step S38.

<Third Mode of Data Transmission Processing in Slave 12>

A third mode of data transmission processing in the slave 12 will be described.

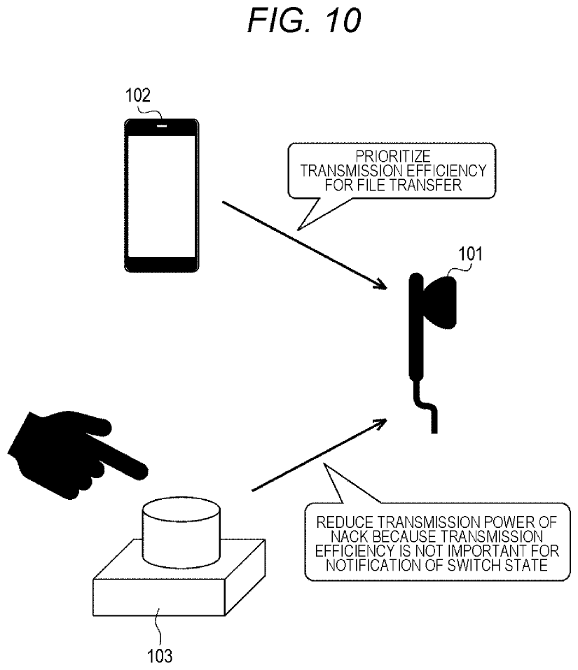

FIG. 10 is a diagram illustrating a third mode of data transmission processing.

In FIG. 10, it is assumed that headphones 101 are communicably connected to a smartphone 102 or a switch device 103 by short-range wireless communication based on the Bluetooth (registered trademark) standard.

For example, assume that the headphones 101 and the smartphone 102 are connected by short-range wireless communication with the headphones 101 as the slave 12 and the smartphone 102 as the master 11. In this connected state, there is a case where data of one file of music, for example, is divided into a plurality of packets and continuously transmitted from the smartphone 102 to the headphones 101. In this case, when the headphones 101 have not received the packet transmitted by smartphone 102 normally, the headphones 101 transmit a negative acknowledgement (NACK) to the smartphone 102. At this time, in the first mode of data transmission processing, in a case where there is no data body to be transmitted by the headphones 101 to the smartphone 102, the headphones 101 transmit the packet to the smartphone 102 with low power. However, in a case where the smartphone 102 has not received a negative acknowledgement (NACK) normally due to the transmission of the negative acknowledgement (NACK) with low power, transmission of the data body from the master 11 to the slave 12 may be delayed and transmission efficiency may decrease as compared with a case where the smartphone 102 has received the negative acknowledgement (NACK) normally. A decrease in transmission efficiency in the case of transmitting data of a file such as music may be undesirable.

On the other hand, assume that the headphones 101 and the switch device 103 are connected with the headphones 101 as the slave 12 and the switch device 103 as the master 11. In this connected state, the switch device 103 may regularly or irregularly transmit data for notifying the headphones 101 of the state of the switch. In this case, when the headphones 101 have not received the data (packet) transmitted from the switch device 103 normally, the headphones 101 transmit a negative acknowledgement (NACK) to the switch device 103. At this time, in the first mode of data transmission processing, in a case where there is no data body to be transmitted to the switch device 103 by the headphones 101, the headphones 101 transmit a negative acknowledgement (NACK) to the switch device 103 with low power. If the switch device 103 has not received a negative acknowledgement (NACK) from the headphones 101 normally due to transmission of the negative acknowledgement (NACK) with low power, transmission of the data body may be delayed, and transmission efficiency may decrease. However, regarding the type of data for providing notification of the state of the switch, there may be no problem even if there is a slight delay in data transmission or a decrease in transmission efficiency.

Therefore, in the third mode of data transmission processing, the slave 12 sets the transmission power for transmitting a negative acknowledgement (NACK) without a data body to low power only in a case where the connection (link) between the master 11 and the slave 12 corresponding to the type of data to be transmitted from the master 11 to the slave 12 is a connection of a type designated in advance. Regarding whether or not the connection is of a type designated in advance, for example, a Bluetooth (registered trademark) profile (which defines communication method, operation procedure, and the like) used for transmission of a type of data that does not cause a problem even if the transmission efficiency decreases is designated in advance, and whether or not the connection between the master 11 and the slave 12 is a connection according to the designated profile is determined.

<Processing Procedure of Third Mode of Data Transmission Processing>

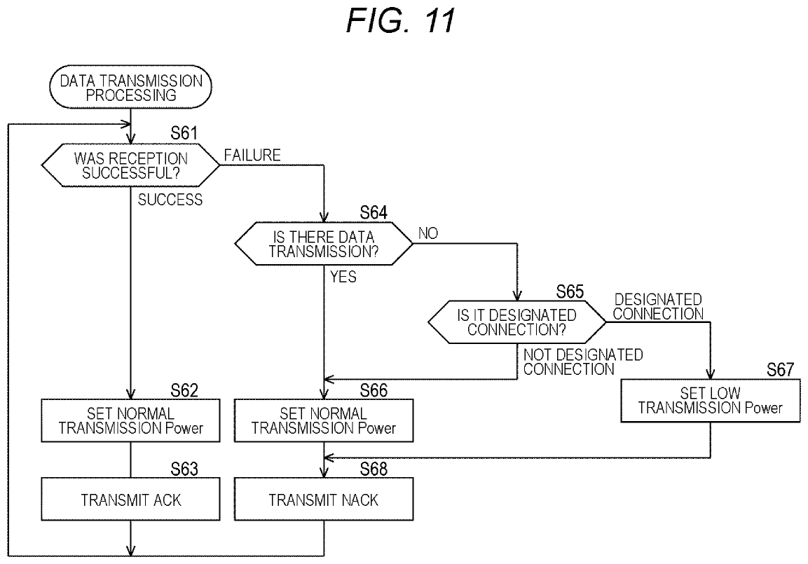

FIG. 11 is a flowchart illustrating a procedure of the third mode of data transmission processing performed by the communication unit 52 of the slave 12.

The processing of steps S61 to S64 and steps S66 to S68 of the flowchart of FIG. 11 is common to the processing of steps S31 to S34 and steps S36 to S38 of the flowchart of FIG. 9.

Noe, however, that the flowchart of FIG. 11 is different from the flowchart of FIG. 9 in that the processing of step S65 is performed instead of step S35 of FIG. 9.

In the flowchart of FIG. 11, processing in step S65 different from the flowchart of FIG. 9 will be mainly described.

The determination processing in step S65 of the flowchart in FIG. 11 is performed when it is determined in step S61 that the reception of the packet from the master 11 has failed and it is determined in step S64 that there is no data body to be transmitted to the master 11 along with a negative acknowledgement (NACK).

In step S65, the transmission power control unit 77 (see FIG. 2) determines whether or not the connection between the master 11 and the slave 12 is a connection of a type designated in advance. The transmission power control unit 77 may determine the type of connection by the data of the “Access Address” field included in the transmission data (packet) generated by the transmission data generation unit 75.

If is determined in step S65 that the connection between the master 11 and the slave 12 is not a connection of the type designated in advance, the processing proceeds to step S66. In step S66, the transmission power control unit 77 sets the transmission power (radio field intensity) for transmitting a negative acknowledgement (NACK) packet from the data transmission unit 76 to normal power. The processing proceeds from step S66 to step S68.

If it is determined in step S65 that the connection between the master 11 and the slave 12 is a connection of the type designated in advance, the processing proceeds to step S67. In step S67, the transmission power control unit 77 sets the transmission power (radio field intensity) for transmitting a negative acknowledgement (NACK) (packet not including data body) from the data transmission unit 76 to low power lower than normal power. The processing proceeds from step S67 to step S68.

<Processing of Master 11>

Processing related to a request for changing the transmission power performed by the master 11 in a case where the slave 12 adopts any one of the first to third modes of the data transmission processing will be described.

In the Bluetooth (registered trademark) standard, each of the master 11 and the slave 12 can change or designate the transmission power of data (packet) transmitted by a communication partner. For example, the master 11 can detect the radio field intensity of transmission radio waves from the slave 12, and request the slave 12 to change the transmission power so that the transmission power becomes appropriate if the detected radio field intensity is inappropriate. Data related to the change of the transmission power is set in, for example, the “Payload” field of the packet to be transmitted to the communication partner.

In a case where the slave 12 changes the transmission power of the packet as in the first to third modes of data transmission processing in the slave 12, the master 11 that has received the packet may determine that the transmission power (radio field intensity of transmission radio waves) of the packet transmitted by the slave 12 is inappropriate and request the slave 12 to change the transmission power. When the slave 12 follows the request for changing the transmission power from the master 11, the transmission power of the packet transmitted by the slave 12 with normal power changes, which may be inappropriate.

Therefore, as a first coping method for preventing such a situation, a method can be adopted in which the slave 12 ignores the request for changing the transmission power given from the master 11 immediately after the reduction in the transmission power of the packet.

As a second coping method, a method can be adopted in which the master 11 does not request a change of the transmission power in a case where the slave 12 changes the transmission power regardless of a request from the master 11. Processing according to the second coping method will be specifically described.

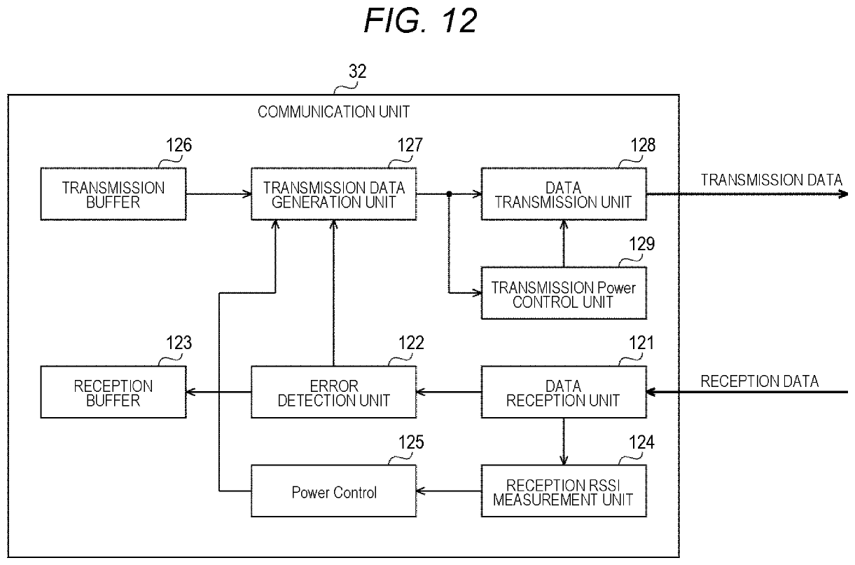

FIG. 12 is a block diagram illustrating a configuration example of the communication unit 32 of the master 11 in FIG. 1.

The communication unit 32 includes a data reception unit 121, an error detection unit 122, a reception buffer 123, a reception RSSI measurement unit 124, a power control unit 125, a transmission buffer 126, a transmission data generation unit 127, a data transmission unit 128, and a transmission power control unit 129.

The data reception unit 121, the error detection unit 122, the reception buffer 123, the transmission buffer 126, the transmission data generation unit 127, the data transmission unit 128, and the transmission power control unit 129 in the communication unit 32 are processing units that perform processing similar to those of the data reception unit 71, the error detection unit 72, the reception buffer 73, the transmission buffer 74, the transmission data generation unit 75, the data transmission unit 76, and the transmission power control unit 77 in the communication unit 52 of the slave 12 in FIG. 2, respectively, and thus detailed description thereof will be omitted and only differences will be described.

The reception RSSI measurement unit 124 detects the radio field intensity of transmission data (packet) from the slave 12 received by the data reception unit 121, and supplies the transmission data (packet) to the power control unit 125.

The power control unit 125 determines whether the transmission power of the slave 12 is appropriate or inappropriate on the basis of the radio field intensity from the reception RSSI measurement unit 124. When determining that the radio field intensity is inappropriate, the power control unit 125 specifies to the transmission data generation unit 127 how much the transmission power of the slave 12 is to be changed with respect to the current set value.

The transmission data generation unit 127 determines whether or not there is an instruction not to make a request for changing the transmission power from the error detection unit 122. That is, the error detection unit 122 determines whether or not a transmission data (packet) transmitted from the slave 12 includes data indicating that the transmission power is intentionally reduced for transmission of a negative acknowledgement (NACK). For example, in a case where the transmission power is intentionally reduced in order to transmit a negative acknowledgement (NACK), the slave 12 sets data indicating the reduction in the transmission power in the “RFU” field or the like of the packet in FIG. 4. In a case where the received transmission data (packet) includes data indicating that the transmission power is intentionally reduced, the error detection unit 122 determines that a request for changing the transmission power to the slave 12 is prohibited. When determining that a request for changing the transmission power to the slave 12 is prohibited, the error detection unit 122 instructs the transmission data generation unit 127 not to request for changing the transmission power.

In a case where an instruction not to request the transmission power change is given from the error detection unit 122, the transmission data generation unit 127 does not include, in the transmission data to the slave 12, data requesting the slave 12 to change the transmission power regardless of the presence or absence of a transmission power change request from the power control unit 125.

As a result, even in a case where the slave 12 reduces the transmission power of the negative acknowledgement (NACK), a situation in which the transmission power of transmission data transmitted from the slave 12 fluctuates due to being affected by the reduction is prevented.

Note that in a case where an instruction not to request the transmission power change is not given from the error detection unit 122, the transmission data generation unit 127 transmits transmission data including data requesting the slave 12 to change the transmission power according to the instruction from the power control unit 125.

<Program>

A series of processing in the first information processing device (master) 11 or the second information processing device (slave) 12 described above can be executed by hardware or software. In a case where the series of processing is executed by software, a program that is included in the software is installed on a computer. Here, the computer includes a computer incorporated in dedicated hardware, a general-purpose personal computer, for example, that can execute various functions by installing various programs, and the like.

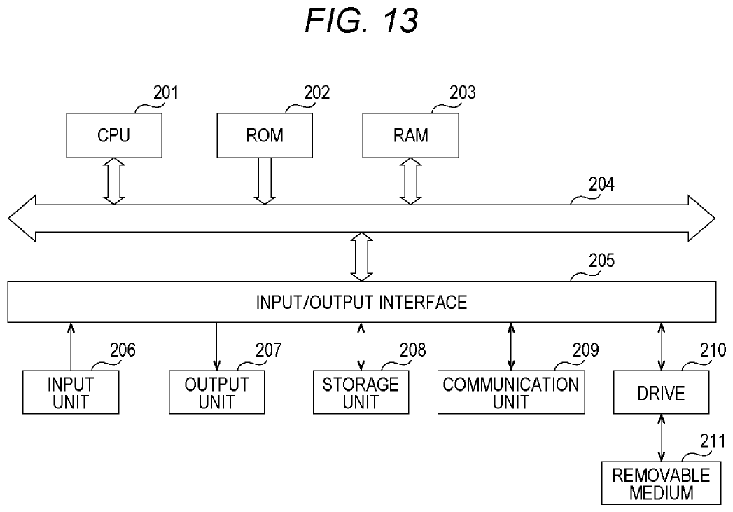

FIG. 13 is a block diagram illustrating a configuration example of hardware of a computer in a case where the computer executes each processing executed by the first information processing device 11 or the second information processing device 12 by a program.

In the computer, a central processing unit (CPU) 201, a read only memory (ROM) 202, and a random access memory (RAM) 203 are mutually connected by a bus 204.

An input/output interface 205 is further connected to the bus 204. An input unit 206, an output unit 207, a storage unit 208, a communication unit 209, and a drive 210 are connected to the input/output interface 205.

The input unit 206 includes a keyboard, a mouse, a microphone and the like. The output unit 207 includes a display, a speaker and the like. The storage unit 208 includes a hard disk, a non-volatile memory, and the like. The communication unit 209 includes a network interface and the like. The drive 210 drives a removable medium 211 such as a magnetic disk, an optical disk, a magnetooptical disk, or a semiconductor memory.

In the computer configured as described above, for example, the CPU 201 loads A program stored in the storage unit 208 into the RAM 203 via the input/output interface 205 and the bus 204 and executes the program, to thereby perform the above-described series of processing.

The program executed by the computer (CPU 201) can be provided by being recorded in the removable medium 211 as a package medium or the like, for example. Furthermore, the program can be provided via a wired or wireless transmission medium such as a local area network, the Internet, or digital satellite broadcasting.

In the computer, the program can be installed in the storage unit 208 via the input/output interface 205 by loading the removable medium 211 in the drive 210. Furthermore, the program can be received by the communication unit 209 via a wired or wireless transmission medium and installed in the storage unit 208. In addition, the program may be installed in advance on the ROM 202 and the storage unit 208.

Note that the program executed by the computer may be a program that performs processing in chronological order according to the order described in the present specification, or a program that performs processing in parallel, or at a necessary timing such as when a call is made.

The present technology can also be configured in the following manner.

(1)

An information processing device including
a communication unit that transmits an acknowledgement to a connection device connected by wireless communication in a case where transmission data transmitted from the connection device has been received normally, and transmits a negative acknowledgement to the connection device in a case where the transmission data has not been received normally, in which
in a case where the negative acknowledgement is transmitted to the connection device and there is no data body to be transmitted to the connection device, the communication unit sets transmission power for transmitting the negative acknowledgement to low power lower than normal power that is transmission power for transmitting other data.

(2)

The information processing device according to (1) above, in which
the communication unit receives the transmission data retransmitted from the connection device in a case where the connection device has received the negative acknowledgement for the transmission data normally or in a case where the connection device has not received any of the acknowledgement or the negative acknowledgement for the transmission data normally.

(3)

The information processing device according to (2) above, in which
the transmission data is retransmitted in a connection interval next to a predetermined connection interval in which the transmission data is transmitted in both a case where the connection device has received the negative acknowledgement for the transmission data normally and a case where the connection device has not received any of the acknowledgement or the negative acknowledgement for the transmission data normally.

(4)

The information processing device according to any one of (1) to (3) above, in which
the communication unit sets the transmission power for transmitting the negative acknowledgement to the normal power or the low power according to a data transmission method of the wireless communication.

(5)

The information processing device according to any one of (1) to (4) above, in which
the communication unit sets the transmission power for transmitting the negative acknowledgement to the normal power in a case where a data transmission method of the wireless communication is ACL transmission.

(6)

The information processing device according to any one of (1) to (5) above, in which
the communication unit sets the transmission power for transmitting the negative acknowledgement to the low power in a case where a data transmission method of the wireless communication is ISO transmission.

(7)

The information processing device according to any one of (1) to (6) above, in which
the communication unit sets the transmission power for transmitting the negative acknowledgement to the normal power or the low power according to a type of connection by the wireless communication.

(8)

The information processing device according to (7) above, in which
the communication unit sets the transmission power for transmitting the negative acknowledgement to the low power in a case where the connection by the wireless communication is a connection of a type designated in advance.

(9)

The information processing device according to any one of (1) to (8) above, in which
the wireless communication is short-range wireless communication.

(10)

The information processing device according to any one of (1) to (9) above, in which
the wireless communication is short-range wireless communication based on a Bluetooth (registered trademark) standard.

(11)

The information processing device according to any one of (1) to (10) above, in which
the wireless communication transmits data by a packet having a predetermined bit length.

(12)

The information processing device according to any one of (1) to (11) above, in which
the communication unit is connected as a slave to the connection device that is a master.

(13)

The information processing device according to any one of (1) to (12) above, in which
the communication unit prohibits the connection device from requesting the communication unit to change the transmission power in a case where the transmission power for transmitting the negative acknowledgement is set to the low power.

(14)

An information processing method including the steps of
a communication unit of an information processing device including the communication unit
transmitting an acknowledgement to a connection device connected by wireless communication in a case where transmission data transmitted from the connection device has been received normally, and transmitting a negative acknowledgement to the connection device in a case where the transmission data has not been received normally, and
in a case where the negative acknowledgement is transmitted to the connection device and there is no data body to be transmitted to the connection device, setting transmission power for transmitting the negative acknowledgement to low power lower than normal power that is transmission power for transmitting other data.

(15)

A program for causing a computer to function as a communication unit that transmits an acknowledgement to a connection device connected by wireless communication in a case where transmission data transmitted from the connection device has been received normally, and transmits a negative acknowledgement to the connection device in a case where the transmission data has not been received normally,
the communication unit setting transmission power for transmitting the negative acknowledgement to low power lower than normal power that is transmission power for transmitting other data in a case where the negative acknowledgement is transmitted to the connection device and there is no data body to be transmitted to the connection device.

### REFERENCE SIGNS LIST

1 Information processing system
11 First information device
12 Second information processing device
31, 51 Processing unit
32, 52 Communication unit
71, 121 Data reception unit
72, 122 Error detection unit
73, 123 Reception buffer
74, 126 Transmission buffer
75, 127 Transmission data generation unit
76, 128 Data transmission unit
124 Reception RSSI measurement unit
125 Power control unit

1. An information processing device comprising
a communication unit that transmits an acknowledgement to a connection device connected by wireless communication in a case where transmission data transmitted from the connection device has been received normally, and transmits a negative acknowledgement to the connection device in a case where the transmission data has not been received normally, wherein
in a case where the negative acknowledgement is transmitted to the connection device and there is no data body to be transmitted to the connection device, the communication unit sets transmission power for transmitting the negative acknowledgement to low power lower than normal power that is transmission power for transmitting other data.

2. The information processing device according to claim 1, wherein
the communication unit receives the transmission data retransmitted from the connection device in a case where the connection device has received the negative acknowledgement for the transmission data normally or in a case where the connection device has not received any of the acknowledgement or the negative acknowledgement for the transmission data normally.

3. The information processing device according to claim 2, wherein
the transmission data is retransmitted in a connection interval next to a predetermined connection interval in which the transmission data is transmitted in both a case where the connection device has received the negative acknowledgement for the transmission data normally and a case where the connection device has not received any of the acknowledgement or the negative acknowledgement for the transmission data normally.

4. The information processing device according to claim 1, wherein
the communication unit sets the transmission power for transmitting the negative acknowledgement to the normal power or the low power according to a data transmission method of the wireless communication.

5. The information processing device according to claim 4, wherein
the communication unit sets the transmission power for transmitting the negative acknowledgement to the normal power in a case where a data transmission method of the wireless communication is ACL transmission.

6. The information processing device according to claim 4, wherein
the communication unit sets the transmission power for transmitting the negative acknowledgement to the low power in a case where a data transmission method of the wireless communication is ISO transmission.

7. The information processing device according to claim 1, wherein
the communication unit sets the transmission power for transmitting the negative acknowledgement to the normal power or the low power according to a type of connection by the wireless communication.

8. The information processing device according to claim 7, wherein
the communication unit sets the transmission power for transmitting the negative acknowledgement to the low power in a case where the connection by the wireless communication is a connection of a type designated in advance.

9. The information processing device according to claim 1, wherein
the wireless communication is short-range wireless communication.

10. The information processing device according to claim 1, wherein
the wireless communication is short-range wireless communication based on a Bluetooth (registered trademark) standard.

11. The information processing device according to claim 1, wherein
the wireless communication transmits data by a packet having a predetermined bit length.

12. The information processing device according to claim 1, wherein
the communication unit is connected as a slave to the connection device that is a master.

13. The information processing device according to claim 1, wherein
the communication unit prohibits the connection device from requesting the communication unit to change the transmission power in a case where the transmission power for transmitting the negative acknowledgement is set to the low power.

14. An information processing method comprising the steps of
a communication unit of an information processing device including the communication unit
transmitting an acknowledgement to a connection device connected by wireless communication in a case where transmission data transmitted from the connection device has been received normally, and transmitting a negative acknowledgement to the connection device in a case where the transmission data has not been received normally, and
in a case where the negative acknowledgement is transmitted to the connection device and there is no data body to be transmitted to the connection device, setting transmission power for transmitting the negative acknowledgement to low power lower than normal power that is transmission power for transmitting other data.

15. A program for causing a computer to function as a communication unit that transmits an acknowledgement to a connection device connected by wireless communication in a case where transmission data transmitted from the connection device has been received normally, and transmits a negative acknowledgement to the connection device in a case where the transmission data has not been received normally,
the communication unit setting transmission power for transmitting the negative acknowledgement to low power lower than normal power that is transmission power for transmitting other data in a case where the negative acknowledgement is transmitted to the connection device and there is no data body to be transmitted to the connection device.
